(19) United States
(12) Patent Application Publication
(10) Pub. No.: US 2026/0219811 A1
(43) Pub. Date: Jul. 30, 2026

(54) SYSTEM, IMAGE FORMING APPARATUS, USER TERMINAL, METHODS OF CONTROLLING THEM, AND STORAGE MEDIUM

(71) Applicant: CANON KABUSHIKI KAISHA, Tokyo (JP)

(72) Inventor: HIROYUKI NAKANE, Chiba (JP)

(21) Appl. No.: 19/449,897

(22) Filed: Jan. 15, 2026

(30) Foreign Application Priority Data
Jan. 27, 2025 (JP) 2025-011661

(51) Int. Cl. G06F 3/12

(52) U.S. Cl. CPC G06F 3/1204; G06F 3/1231; G06F 3/1236

(57) ABSTRACT

The present disclosure is directed to an image forming apparatus, comprising: one or more first memory devices that store a set of instructions; and one or more first processors that execute the set of instructions to present, to a user terminal, related information for accepting an input of a license key that enables an image forming speed, accept the input of the license key that the user terminal has acquired from a server with use of the related information, and enable the image forming speed in accordance with the input license key.

### BACKGROUND

### Field of the Technology

The present disclosure relates to a system that can change a printing speed under a license, an image forming apparatus, a user terminal, methods of controlling them, and a storage medium.

### Description of the Related Art

Some of the existing image forming apparatuses are provided to the market as other models with different speeds as a result of changing a printing speed in the same hardware configurations. A method is also proposed that switches from a slow printing speed to a fast printing speed by inputting a license (speed license) to an image forming apparatus after shipment from a factory.

A speed license is issued by inputting, to a license management server, a device serial number of an image forming apparatus and license access numbers that respectively correspond to changeable printing speeds of the image forming apparatus. Therefore, in order for a user to change a printing speed of an image forming apparatus, the user needs to input a device serial number and a license access number to the license management server, and input an issued speed license to the image forming apparatus, by him/herself; this procedure is cumbersome, and also could cause erroneous inputs. Japanese Patent Laid-Open No. 2008-140324 proposes a technique to establish coordination among an image forming apparatus, a license management server, and a user terminal, thereby enabling a license without a manual input by a user.

However, the aforementioned conventional technique is based on the premise that network settings have already been configured on the image forming apparatus, and the image forming apparatus can also connect to the external license management server. Therefore, a situation can arise where the external license management server and the image forming apparatus cannot connect to each other directly depending on circumstances of a network environment of a place of installation, such as a client's site. In this case, the user needs to manually perform a license input from a UI of the image forming apparatus; this is cumbersome, and also could cause erroneous inputs.

### SUMMARY

The present disclosure enables realization of a novel mechanism for inputting a license to an image forming apparatus.

One aspect of the present disclosure provides a system including an image forming apparatus, a user terminal, and a server, the image forming apparatus comprising: one or more first memory devices that store a set of instructions; and one or more first processors that execute the set of instructions to present related information for accepting an input of a license key that enables an image forming speed, and enable the image forming speed in accordance with the input license key, the user terminal comprising: one or more second memory devices that store a set of instructions; and one or more second processors that execute the set of instructions to acquire device information of the image forming apparatus in accordance with the presented related information, acquire selectable image forming speeds by notifying the server of the acquired device information of the image forming apparatus, present the selectable image forming speeds and select an image forming speed in response to a user input, and acquire a license key corresponding to the selected image forming speed from the server and input the license key to the image forming apparatus, and the server comprising: one or more third memory devices that store a set of instructions; and one or more third processors that execute the set of instructions to provide a notification of the selectable image forming speeds in accordance with the device information, and issue the corresponding license key in accordance with the selected image forming speed.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram showing a configuration of an image forming apparatus according to an embodiment.

FIG. 2 is a diagram showing an overall configuration of a system of a license management server and a user terminal related to the image forming apparatus according to an embodiment.

FIG. 3 is a sequence diagram of the entire system according to an embodiment.

FIG. 4A is a diagram showing UI screens of the image forming apparatus according to an embodiment.

FIG. 4B is a diagram showing UI screens of the image forming apparatus according to an embodiment.

FIG. 5A is a diagram showing UI screens of the image forming apparatus according to an embodiment.

FIG. 5B is a diagram showing UI screens of the image forming apparatus according to an embodiment.

FIG. 6 is a sequence diagram of the entire system according to an embodiment.

FIG. 7 is a diagram showing a speed license registration UI screen for prompting BLE enablement in the image forming apparatus according to an embodiment.

FIG. 8 is a diagram showing UI screens on the user terminal that indicate a result of connection to the image forming apparatus according to an embodiment.

FIG. 9 is a sequence diagram of the entire system according to an embodiment.

FIG. 10 is a diagram showing UI screens of the image forming apparatus according to an embodiment.

FIG. 11 is a diagram showing a UI screen for prompting scanning of a QR code (Registered Trademark) of a speed license purchased on the user terminal according to an embodiment.

FIG. 12 is a sequence diagram of the entire system according to an embodiment.

FIG. 13 is a diagram showing a speed license registration UI screen for prompting a USB connection in the image forming apparatus according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Configuration of Image Forming Apparatus

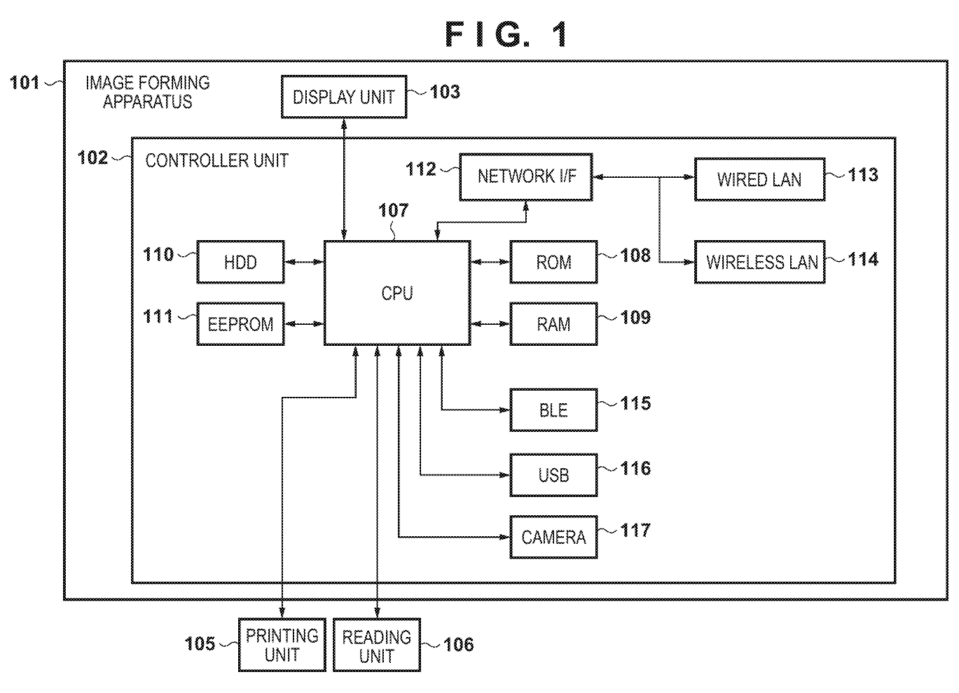

The following describes a first embodiment of the present disclosure. With reference to FIG. 1, an exemplary configuration of an image forming apparatus 101 according to the present embodiment will be described. The image forming apparatus 101 is configured to include a controller unit 102, a display unit 103, a printing unit 105, and a reading unit 106.

The display unit 103 includes an LED or liquid crystal display, and displays the contents of user operations and internal information of the apparatus. Note that it is also possible to provide display information to an external apparatus connected via a network, and display the display information on a display unit of the external apparatus. The display unit 103 accepts operations from a user, and is controlled by a CPU 107. Furthermore, in some cases, the display unit 103 not only includes a plurality of operation buttons, but also is realized as a touch display on which both display and operations can be performed.

The printing unit 105 accepts a printing instruction from the controller unit 102, and performs printing on a sheet based on image data transmitted from the controller unit 102. Also, it switches an actual printing speed in accordance with a printing speed instruction of which it is notified by the controller unit 102 at start-up. The reading unit 106 accepts a reading instruction from the controller unit 102, performs a reading operation, and transmits image data thereof to the controller unit 102. Note that although the present embodiment is described using a printing speed in the printing unit 105 as an example, the printing unit 105 of the present image forming apparatus 101 has not only a printing function, but also a copy function, and a facsimile function, and the like. Therefore, although the present description will be provided using the term "printing speed", it can also be referred to as an image forming speed of the image forming apparatus 101 in consideration of the copy function, the facsimile function, and the like. That is to say, the printing speed is an example of the image forming speed.

The controller unit 102 is configured to include the CPU 107, a ROM 108, a RAM 109, an HDD 110, an EEPROM 111, a network I/F 112, a wired LAN 113, a wireless LAN 114, BLE 115, USB 116, and a camera 117. The CPU 107 is a medium for execution of control programs, which is built in the image forming apparatus 101 and controls operations of apparatuses connected to the controller unit 102 via each I/F, a memory of a storage medium, and the like. The ROM 108 is a read-only memory, and stores, for example, a boot program necessary for system start-up. The RAM 109 is a volatile memory, and is a working memory that is required when executing control programs.

The HDD 110 is a storage medium like a magnetic disk, and stores control programs, image data, and the like. The EEPROM 111 is a nonvolatile memory, and stores, for example, setting values that are required when control programs are executed. Furthermore, a device serial number for individual identification and information indicating a printing speed of which the printing unit 105 is to be notified are also held in the EEPROM 111. A printing speed of the image forming apparatus 101 is enabled by inputting a 24-digit license key to a later-described license key input screen. Note that the number of digits of the license key is not intended to limit the present disclosure, and any number of digits can be applied. Here, as this license key is a license that decides a printing speed, it is referred to as a speed license.

The network I/F 112 connects to an external apparatus via the wired LAN 113 or the wireless LAN 114. The wired LAN 113 controls NIC communication, including the wireless LAN 114. The wireless LAN 114 communicates with a later-described user terminal 211 via the network I/F 112.

The BLE 115 is a BLE module for performing BLE communication. Here, the BLE communication is communication compliant with Bluetooth Low Energy^{®}. The BLE 115 performs BLE communication with the later-described user terminal 211. The USB 116 is an interface via which the image forming apparatus 101 is connected to the user terminal 211 and a USB device (not shown), and controls communication with the USB device connected to the image forming apparatus 101. Although only one USB 116 is described in the present embodiment, a plurality of USBs 116 exist in reality. The USB 116 is connected to the USB device via a USB cable. They are connected directly to each other without using the USB cable, depending on the form of the USB device. The camera 117 is a module that controls a camera device connected to the image forming apparatus 101, and is controlled by the CPU 107. Images captured by the camera 117 are stored in the RAM 109 or the HDD 110.

### System Configuration

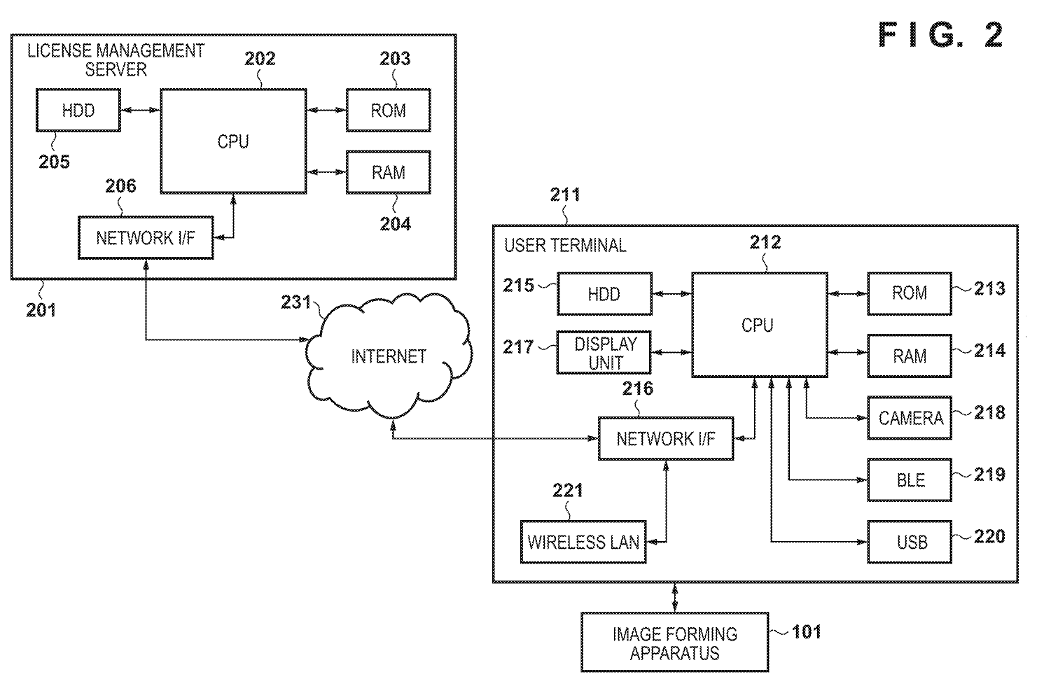

With reference to FIG. 2, a description is now given of an exemplary overall configuration of a system including a license management server 201 and the user terminal 211 related to the image forming apparatus 101 according to the present embodiment. Although the details of the user terminal 211 will be described later, the user terminal 211 can communicate with the license management server 201 via the Internet 231.

The license management server 201 manages device serial numbers of a plurality of image forming apparatuses, and issued license keys. A device serial number is a unique individual identification number for identifying an image forming apparatus. The license management server 201 issues a 24-digit license key (speed license) that can be activated on the image forming apparatus 101 from a device serial number and a license access number indicating a license type. The license management server 201 manages the device serial number, the license access number, and the license key in association with one another.

A configuration of the license management server 201 is now described. The license management server 201 is configured to include a CPU 212, a ROM 203, a RAM 204, an HDD 205, and a network I/F 206. The CPU 212 is a medium for execution of a server function of the license management server 201. The ROM 203 is a read-only memory, and stores, for example, a boot program necessary for system start-up. The RAM 204 is a volatile memory, and is a working memory that is required when executing programs of the server function. The HDD 205 is a storage medium like a magnetic disk, and stores programs of the server function, device serial numbers, license access numbers, and issued speed licenses. The license management server 201 can communicate with the user terminal 211 and provides issued speed licenses to the user terminal 211 via the Internet 231.

A configuration of the user terminal 211 is now described. The user terminal 211 is configured to include a CPU 212, a ROM 213, a RAM 214, an HDD 215, a network I/F 216, a camera 218, and BLE 219. The CPU 212 is a medium for execution of control programs, which is built in the user terminal 211. The ROM 213 is a read-only memory, and stores, for example, a boot program necessary for system start-up. The RAM 214 is a volatile memory, and is a working memory that is required when executing control programs. The HDD 215 is a storage medium like a magnetic disk, and stores control programs, data acquired by the control programs, and the like.

The display unit 217 includes an LED or liquid crystal display, displays the contents of operations on the user terminal 211 and internal information of the apparatus, and accepts operations. Furthermore, in some cases, the display unit 217 not only includes a plurality of operation buttons, but also is realized as a touch display. The camera 218 is a module that controls a camera device built in the user terminal, and is controlled by the CPU 212. Images captured by the camera 218 are stored in the RAM 214 or the HDD 215.

The BLE 219 is a BLE module for performing BLE communication. Here, the BLE communication is communication compliant with Bluetooth Low Energy. The BLE 219 performs BLE communication with the image forming apparatus 101. The image forming apparatus 101 transmits a communication packet that requests connection, the user terminal 211 performs a packet scan, and the image forming apparatus 101 and the user terminal 211 establish one-to-one connection communication while serving as a peripheral device (slave) and a central device (master), respectively. The user terminal 211 can communicate with the license management server 201 via the Internet 231, and a device serial number of the image forming apparatus 101 and issued speed licenses are provided to the user terminal 211.

The USB 220 is an interface via which the user terminal 211 is connected to the image forming apparatus 101 and a USB device (not shown), and controls communication with the USB device connected to the user terminal 211. Although only one USB 220 is described in the present embodiment, a plurality of USBs 220 exist in reality. The USB 220 is connected to the USB device via a USB cable. They are connected directly to each other without using the USB cable, depending on the form of the USB device. The network I/F 216 controls NIC communication, including a wireless LAN 221. The wireless LAN 221 communicates with the image forming apparatus 101 via the network I/F 216.

### Sequence

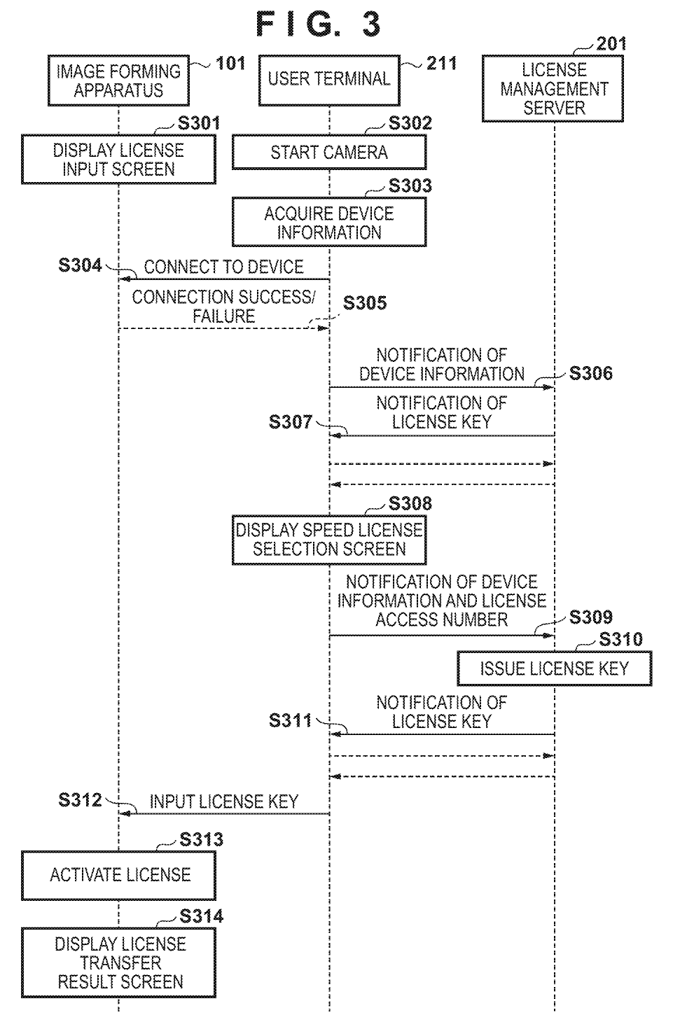

With reference to FIG. 3, a description is now given of a flow until a speed license is activated for the image forming apparatus 101 by the image forming apparatus 101, the user terminal 211, and the license management server 201. The present processing is realized, for example, by the CPU 107 executing a control program on the image forming apparatus 101, the CPU 212 executing a control program on the user terminal 211, and the CPU 202 executing a program for execution of the server function on the license management server 201.

In step S301, the CPU 107 of the image forming apparatus 101 displays a license input screen on the display unit 103 in a case where a power source of the image forming apparatus 101 has been turned ON and a speed license has not been activated. For example, the CPU 107 determines whether a speed license has been activated by referring to a predetermined flag held in the HDD 110. Alternatively, the CPU 107 may determine whether a speed license has been activated based on whether a valid speed license key is held.

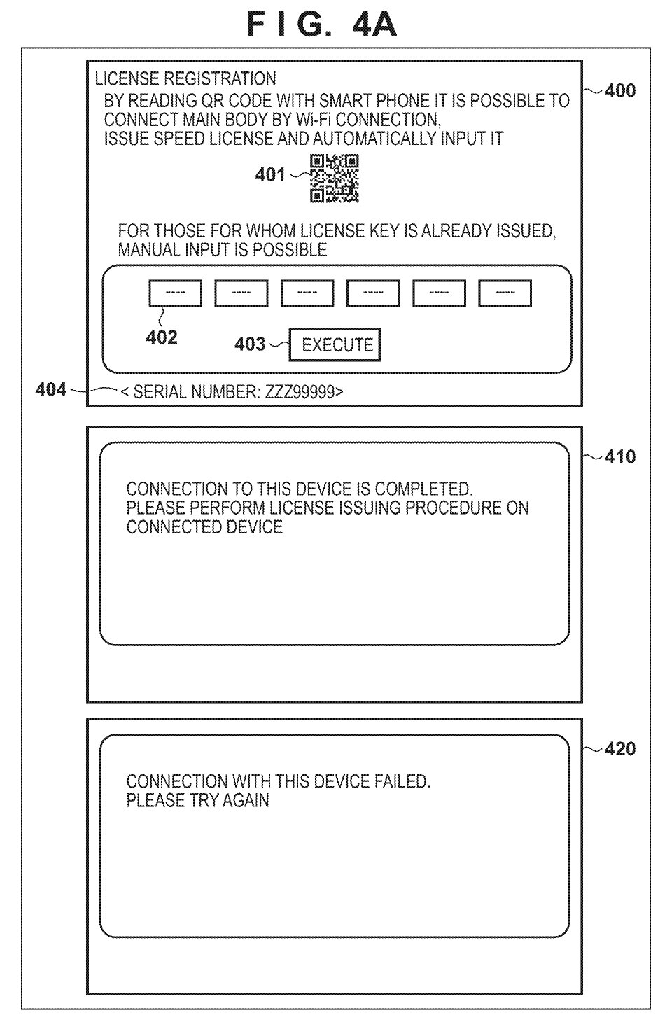

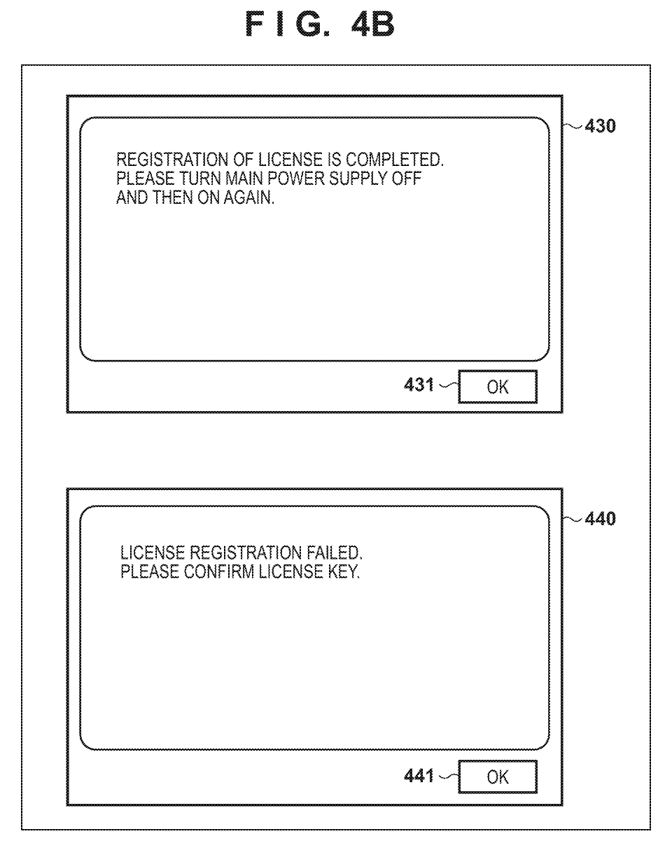

Here, the license input screen displayed on the display unit 103 will be described using FIG. 4A. Display on the display unit 103 is controlled by the CPU 107. Here, the CPU 107 is an example of presentation unit. A license input screen 400 is configured to include a QR code^{®}401, a speed license input section 402, an execution button 403, and a device serial number 404 of the image forming apparatus 101. The CPU 107 generates and displays the QR code 401, which stores the device serial number of the image forming apparatus 101, service set identifier (SSID) information, and password information, and a URL of the license management server 201. The QR code 401 of the present embodiment corresponds to related information for accepting an input of a license key that enables a printing speed. The SSID information is SSID information of the wireless LAN 114 for making Wi-Fi connection to the user terminal 211. As the present embodiment is described based on the premise that the user terminal 211 is not aware of the URL of the license management server 201, the QR code 401 includes URL information of the license management server 201. On the other hand, in a case where the user terminal 211 holds the URL of the license management server 201 in advance, like when a dedicated application for accessing the license management server 201 has been installed therein, the CPU 107 need not include the URL of the license management server 201 in the QR code 401. Alternatively, the CPU 107 may store a URL of an installation server (not shown) of the dedicated application, in place of the URL of the license management server 201, in the QR code 401. In this case, a similar effect can be achieved by accessing the license management server 201 from the dedicated application installed on the user terminal 211. Note that although the present embodiment is described using the QR code including various types of information as an example, the present disclosure is not limited to this, and the QR code may be a code image including various types of information, such as a barcode image, or another image.

The speed license input section 402 is an input space for accepting a manual input when a speed license has already been issued. The present embodiment is described in relation to an example in which the speed license is automatically input; however, in a case where a user manually inputs the speed license, the speed license is input to the speed license input section 402. In this case, the CPU 107 makes a transition to processing for activating the speed license when the speed license has been input to the speed license input section 402 and pressing of the execution button 403 has been detected. The device serial number 404 is a device serial number of the image forming apparatus 101. Although the present embodiment is described in relation to an example in which the device serial number is automatically acquired, the user can also confirm the device serial number 404.

The description of FIG. 3 now resumes. In step S302, the CPU 212 of the user terminal 211 starts the camera 218 of the user terminal 211 by controlling the camera, and displays moving images that are currently captured by the camera on the display unit 217. The present embodiment is described in relation to an example in which the camera 218 is started by a program stored in the user terminal 211. However, in a case where the URL of the license management server 201 is held in advance, the camera 218 may be activated in response to access to the license management server 201, by the license management server 201 prompting the user terminal 211 to activate the camera. Note that although step S302 follows step S301 in the present description, there is no problem in executing steps S301 and S302 in parallel, or executing step S302 first.

Next, in step S303, the CPU 212 reads the QR code 401 displayed on the license input screen 400, which was displayed in step S301, with use of the camera 218, and extracts device information by decoding the QR code. The device information includes the aforementioned device serial number of the image forming apparatus 101, SSID information and password information of the wireless LAN 114 for making Wi-Fi connection to the user terminal 211, and the URL of the license management server.

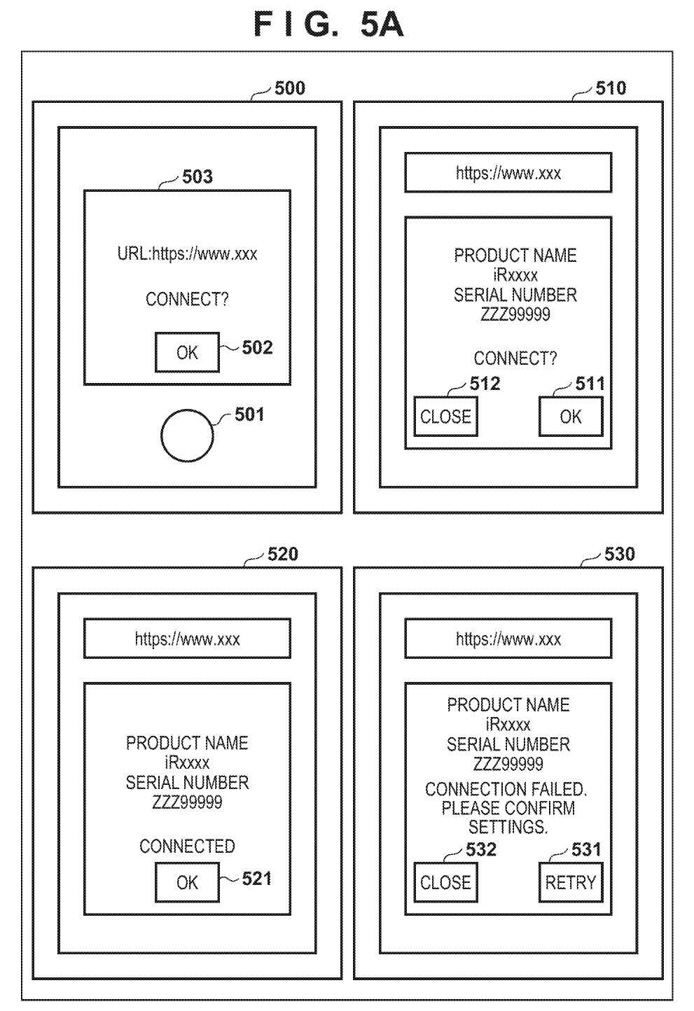

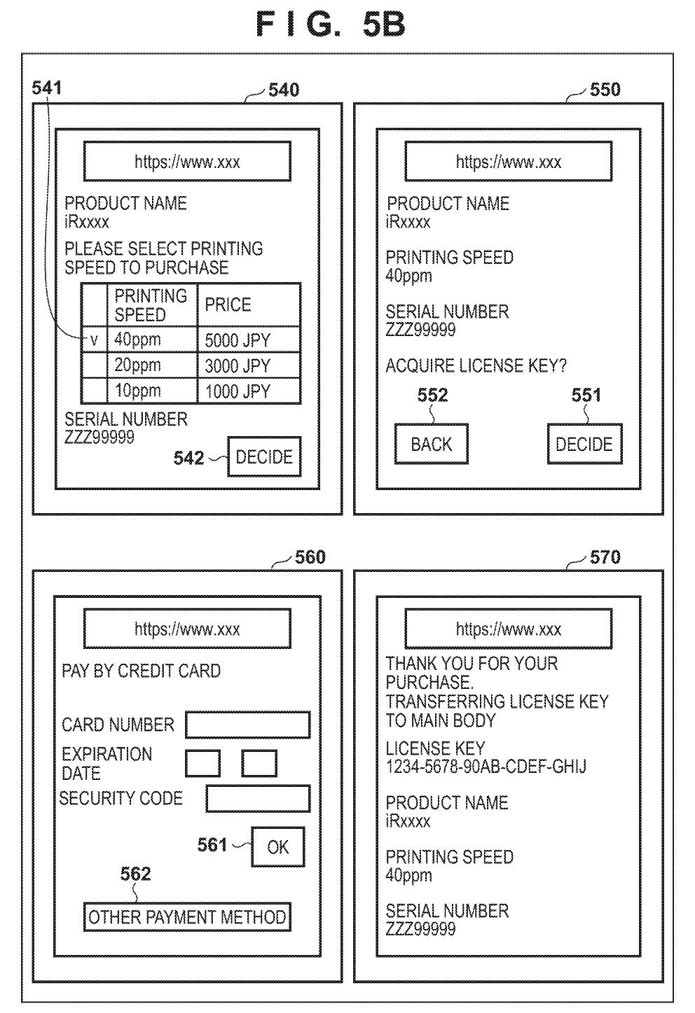

In step S304, the CPU 212 makes Wi-Fi connection to the image forming apparatus 101 with use of the acquired SSID and password by controlling the wireless LAN 221. With reference to FIG. 5A, a description is now given of a screen 500 for confirmation on URL connection and a screen 510 for confirmation on connection to the image forming apparatus 101, which are displayed on the display unit 217. Display of these screens on the display unit 217 is controlled by the CPU 212.

The screen 500 for confirmation on URL connection to the license management server is a screen that displays a confirmation on whether to access the acquired URL on the display unit 217 after the CPU 212 has captured and decoded the QR code 401 by controlling the camera 218. An image capturing button 501 is a decide button to be pressed when the CPU 212 detects the QR code with use of the camera 218. When the image capturing button 501 has been pressed in a state where the QR code 401 has been framed, the QR code is read, and a confirmation 503 on connection to the URL of the license management server, which is included in the QR code, is displayed as a result of decoding of this QR code. Upon detecting pressing of an OK button 502, the CPU 212 starts to access the license management server.

The screen 510 for confirmation on connection to the image forming apparatus is a screen that displays the device information acquired from the QR code 401, and confirms whether to establish a Wi-Fi connection to the image forming apparatus 101 from the acquired SSID and password. Upon detecting pressing of an OK button 511, the CPU 212 proceeds to step S304. Upon detecting pressing of a close button 512, the screen is closed without connecting to the image forming apparatus 101.

The description of FIG. 3 now resumes. In step S305, the CPU 107 returns a connection success in a case where the Wi-Fi connection has been established using the SSID and password accessed by the user terminal 211, and provides a notification of a connection failure in a case where connection has failed. With reference to FIG. 4A, a description is now given of a connection result screen that is displayed on the display unit 103 in relation to display on the image forming apparatus 101. Display on the display unit 103 is controlled by the CPU 107. A connection success screen 410 is a screen that displays a message indicating that the image forming apparatus 101 and the user terminal 211 have been connected, and prompting the issuance of a speed license on the user terminal 211. A connection failure screen 420 is a screen that displays a message prompting retry of connection processing because connection between the image forming apparatus 101 and the user terminal 211 has failed. The CPU 107 displays one of the screens depending on the connection result in step S305. Similarly, with reference to FIG. 5A, a description is now given of display of a connection confirmation result on the user terminal 211. The CPU 212 displays the connection result of which it has been notified by the image forming apparatus 101 in step S305 on the display unit 217. A connection success screen 520 displays a product name and a device serial number of the image forming apparatus 101 that has connected to the user terminal 211, as well as a connection success, and the CPU 212 closes the screen upon detecting pressing of an OK button 521. Meanwhile, a connection failure screen 530 displays the product name and the device serial number of the image forming apparatus 101 that attempted to connect to the user terminal 211, as well as a message prompting reconfirmation of settings as the connection has failed, and the CPU 212 closes the screen upon detecting pressing of a close button 532. On the other hand, the CPU 212 makes a connection attempt again upon detecting pressing of a retry button 531.

In step S306, the CPU 212 notifies the license management server 201 of the device serial number. Thereafter, in step S307, the CPU202 specifies printing speeds that can be selected on the image forming apparatus 101 from the device serial number of which it has been notified in step S306, and notifies the user terminal 211 of license access numbers corresponding to the selectable printing speeds. Note that a license access number indicating one printing speed that can be selected on a model is unique. While easy-to-understand printing speeds are demonstrated for a user, license access numbers that are necessary for an input of a license key are demonstrated inside the system.

In step S308, the CPU 212 displays a screen for selecting a printing speed to be applied to the image forming apparatus 101 on the display unit 217. With reference to FIG. 5B, a description is now given of display on the user terminal 211. The CPU 212 displays the printing speeds that can be selected on the image forming apparatus 101, of which it has been notified by the license management server 201 in step S307, on the display unit 217. A printing speed selection screen 540 displays desired printing speeds in association with prices, in a selectable manner, in a printing speed selection region 541. Each printing speed can be selected by applying a checkmark to a checkbox via a user input. A printing speed is expressed in a unit of page per minute (PPM), which indicates the number of printed sheets that can be processed in one minute. An image forming apparatus of 40 PPM can print 40 pages per minute. In general, this PPM is the fastest printing speed on the image forming apparatus, and there are cases where the number of printed sheets per minute is 40 pages or less depending on the type and basis weight of printing sheets, and a print setting, such as double-sided printing. A change in a printing speed can be realized by the printing unit 105 changing an interval between sheets that are printed continuously, or the speed of drum rotation or sheet conveyance.

Upon detecting pressing of a decide button 542 on the printing speed selection screen 540 via a user input, the CPU 212 carries out a procedure for purchasing a speed license of the printing speed corresponding to a checkbox that has been checked. In order to confirm whether the selected result is accurate, the CPU 212 displays a speed license confirmation screen 550 on the display unit 217. The CPU 212 executes speed license purchase processing upon detecting pressing of a decide button 551, and displays the printing speed selection screen 540 back again upon detecting pressing of a return button 552.

After the decide button 551 has been pressed, the CPU 212 displays a speed license purchase screen 560 on the display unit 217. This screen is an example of a case where a payment for the speed license is made through a credit card transaction. Once a card number, an expiration date, and a security code that are necessary for the transaction have been input and the CPU 212 has detected pressing of an OK button 561, online credit card transaction processing takes place. If an other payment methods button 562 has been pressed, a screen indicating transaction methods other than the credit card transaction is displayed. As the details of the transaction processing is not the principle of the present embodiment, a description thereof is omitted.

The present embodiment has been described using an example in which, in steps S306 to S308, the license management server 201 determines the printing speeds that can be selected on the image forming apparatus 101 from the device serial number. However, this is not intended to limit the present disclosure, and the image forming apparatus 101 or the user terminal 211 may specify the printing speeds that can be selected on the image forming apparatus 101 from the device serial number. In a case where the image forming apparatus 101 specifies the printing speeds, information of the device serial number and the selectable license access numbers that are necessary for the specification is stored in the HDD 110 of the image forming apparatus 101. When creating the QR code 401, the CPU 107 includes therein the selectable license access numbers in addition to the device serial number, the SSID information, the password information, and the URL of the license management server 201, and notifies the user terminal 211 of them simultaneously in step S303. Here, the device serial number, the SSID information, and the password correspond to access information for accessing the image forming apparatus 101. Also, the URL of the license management server 201 corresponds to access information for accessing the license management server 201. Furthermore, the selectable license access numbers correspond to selectable image forming speeds (printing speed) that have been requested. In a case where the user terminal 211 specifies the printing speeds, information of the device serial number and the selectable license access numbers that are necessary for the specification is stored in the HDD 215 of the user terminal 211, and the CPU 212 reads out and uses such information.

In step S309, the CPU 212 notifies the license management server 201 of the device serial number and the license access number selected in step S308. Thereafter, in step S310, the CPU 202 issues a license key from the device serial number and the license access number. When input to the image forming apparatus 101, this license key is activated and thereafter enables printing at a desired speed. The license key is 24-digit alphanumeric characters that are issued to be unique with respect to the device serial number, and the device serial number can be specified from the license key. Therefore, a speed license of another image forming apparatus cannot be activated on a predetermined image forming apparatus of the same product type.

In step S311, the CPU 202 notifies the user terminal 211 of the issued speed license. Thereafter, in step S312, the CPU 212 notifies the image forming apparatus 101 of the speed license acquired in step S311. The CPU 107 of the image forming apparatus 101 accepts the speed license of which it has been notified. Here, the CPU 107 functions as acceptance unit. With reference to FIG. 5B, a description is now given of a screen that is displayed on the display unit 217 when providing the notification of the speed license. A license transfer screen 570 performs display to the effect that the speed license selected in step S308 has been purchased, and the speed license is to be transferred to the image forming apparatus 101 via the Wi-Fi connection between the image forming apparatus 101 and the user terminal 211 that was made in steps S304 and S305. Furthermore, the license transfer screen 570 displays the product name, the purchased printing speed, and the device serial number.

In step S313, the CPU 107 activates the speed license accepted in step S312. The CPU 107 confirms whether the device serial number included in the speed license matches the device serial number of the image forming apparatus 101 by analyzing the speed license. Furthermore, the CPU 107 acquires the printing speed included in the speed license by analyzing the speed license. The CPU 107 replaces the printing speed held in the EEPROM 111 with the acquired printing speed by rewriting the same. The printing unit 105 is notified of the rewritten printing speed at the time of start-up; as a result, an actual printing speed is determined.

In step S314, after rewriting of the printing speed has been completed in step S313, the CPU 107 displays the completion of the change in the printing speed under the speed license on the display unit 103. With reference to FIG. 4B, a description is now given of a connection result screen that is displayed on the display unit 103 in relation to display on the image forming apparatus 101. Display on the display unit 103 is controlled by the CPU 107. In a case where the change in the printing speed of the image forming apparatus 101 has succeeded, the CPU 107 displays a license registration success screen 430, which includes a message indicating the completion of license registration and prompting a restart, on the display unit 103. On the other hand, in a case where the change in the printing speed of the image forming apparatus 101 has failed, the CPU 107 displays a license registration failure screen 440, which includes a message indicating the failure in license registration and prompting confirmation of the license key, on the display unit 103.

As described above, a system is provided that includes the image forming apparatus, the user terminal, and the server according to the present embodiment. The present image forming apparatus presents related information for accepting an input of a license key that enables an image forming speed, and enables the image forming speed in accordance with the input license key. The present user terminal acquires device information of the image forming apparatus in accordance with the presented related information, notifies the server of the acquired device information of the image forming apparatus, and acquires selectable image forming speeds. Also, the present user terminal presents the selectable image forming speeds, selects an image forming speed in accordance with a user input, acquires a license key corresponding to the selected image forming speed from the server, and inputs the license key to the image forming apparatus. Furthermore, the present server provides a notification of the selectable image forming speeds in accordance with the device information, and issues a corresponding license key in accordance with a selected image forming speed. In this way, according to the present embodiment, the user terminal 211 reads code information, such as a QR code, displayed on a license input screen of the image forming apparatus 101 at the time of registration of a speed license, and acquires a speed license based on a selected printing speed. Furthermore, processing is executed to pass the acquired speed license to the image forming apparatus 101 via Wi-Fi and activate (enable) the speed license; in this way, a desired printing speed can be set without performing cumbersome processing and a manual input.

### Second Embodiment

The following describes a second embodiment of the present disclosure. The above first embodiment has been described in relation to an example in which, in order to connect the image forming apparatus 101 and the user terminal 211, a setup for Wi-Fi communication is simplified with use of code information, such as a QR code, in making the connection; however, a similar effect can be achieved by using BLE communication. Today, image forming apparatuses that are offered for sale are configured in a variety of ways; for example, they are equipped only with the wireless LAN 114, equipped only with the BLE 115, or equipped with both options. In view of this, the present embodiment will be described in relation to an example in which a desired printing speed can be set without performing cumbersome processing and a manual input on image forming apparatus with different configurations. Regarding the system of the image forming apparatus 101 and the overall system of the image forming apparatus 101, the user terminal 211, and the license management server 201 shown in FIG. 1 and FIG. 2, the present embodiment is similar to the above-described first embodiment, and therefore a description thereof is omitted.

### Sequence

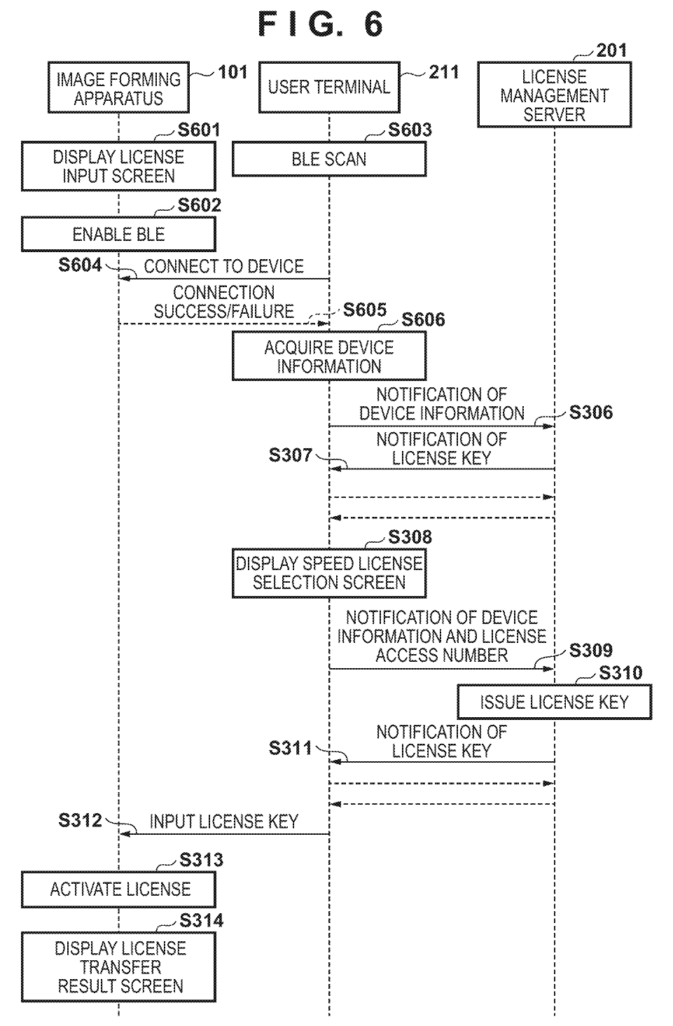

With reference to FIG. 6, a description is now given of a flow until a speed license is activated for the image forming apparatus 101 by the image forming apparatus 101, the user terminal 211, and the license management server 201 according to the present embodiment. The present processing is realized by the CPU 107 executing a control program in the image forming apparatus 101, the CPU 212 executing a control program in the user terminal 211, and the CPU 202 executing a program for execution of the server function in the license management server 201. Note that processing similar to that of the above-described first embodiment is given the same step numbers thereas, and a description thereof is omitted.

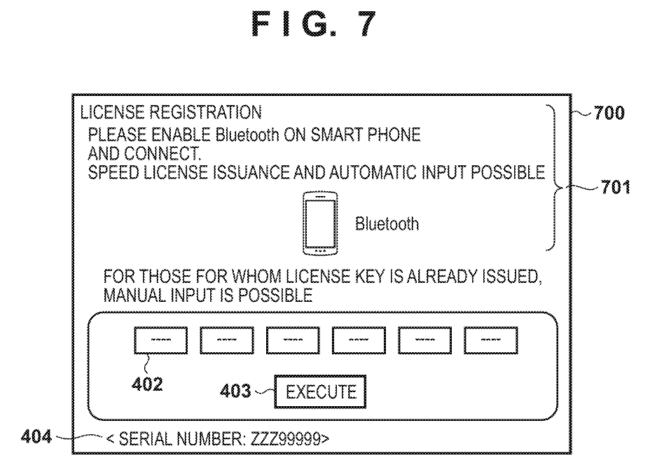

In step S601, the CPU 107 of the image forming apparatus 101 displays a license input screen on the display unit 103 in a case where a power source of the image forming apparatus 101 has been turned ON and a speed license has not been activated. Here, the CPU 107 is an example of presentation unit. As a determination method is similar to the above-described step S301, a detailed description thereof is omitted. Here, the license input screen displayed on the display unit 103 will be described using FIG. 7. Display on the display unit 103 is controlled by the CPU 107. A license input screen 700 is configured to include a message 701, a speed license input section 402, an execution button 403, and a device serial number 404 of the image forming apparatus 101. The message 701 includes content indicating that a speed license is issued and automatically input via Bluetooth^{®} connection, instead of the QR code 401 of the above-described first embodiment. Here, the message 701 of the present embodiment corresponds to related information for accepting an input of a license key that enables a printing speed. As 402 to 404 are similar to those on the license input screen 400, a description thereof is omitted.

In step S602, in order for the image forming apparatus 101 to behave as a peripheral device, the CPU 107 activates the BLE 115, performs advertising to send predetermined information, and waits for a connection from the user terminal 211. Note that the CPU 107 performs this advertising including a product name and a device serial number. In this way, the search for the image forming apparatus 101 can be performed easily at the time of connection to the user terminal 211, which will be described later.

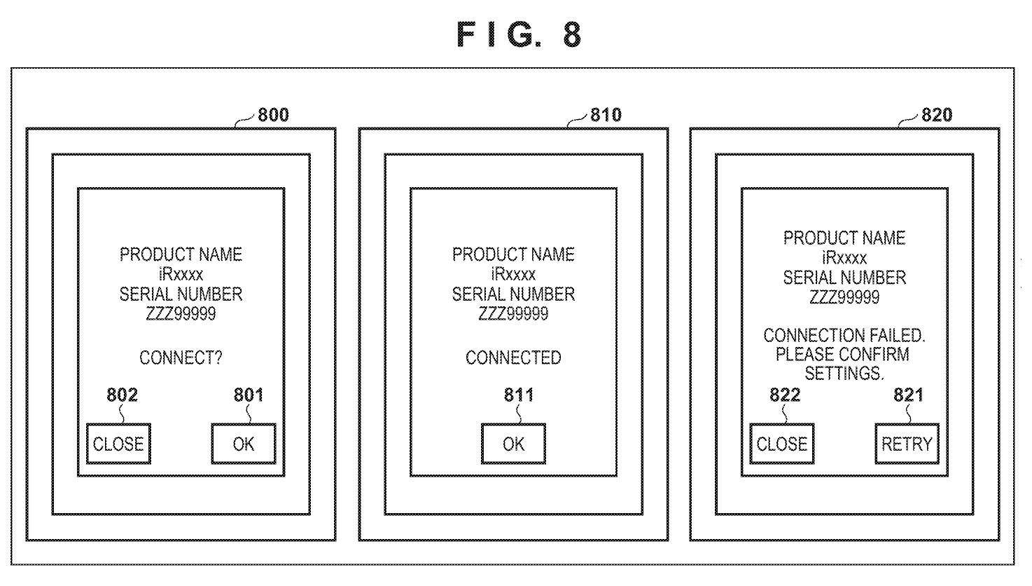

In step S603, in order to behave as a central device, the CPU 212 starts the BLE 219 of the user terminal 211 and performs a scan. In step S604, the CPU 212 displays a list of BLE devices that have been advertised, and makes Bluetooth connection by providing a connection request to a selected BLE device. Note that the CPU 212 prevents a user from erroneously establishing a Bluetooth connection with another BLE device by displaying the product name and the device serial number, which are attribute data appended to the advertising, on the display unit 217. With reference to FIG. 8, a description is now given of a screen for confirmation on connection to the image forming apparatus 101, which is displayed on the display unit 217. Display on the display unit 217 is controlled by the CPU 212. A screen 800 for confirmation on connection to the image forming apparatus is a screen that displays device information that was acquired at the time of connection to a BLE device, and confirms whether to make BLE connection. Upon detecting pressing of an OK button 801, the CPU 212 proceeds to step S605 and waits for completion of connection. Upon detecting pressing of a close button 802, the screen is closed without connecting to the image forming apparatus 101.

In step S605, the CPU 107 returns a connection success in a case where connection has been established in response to the BLE connection request from the user terminal 211, and provides a notification of a connection failure in a case where connection has failed. Regarding display on the image forming apparatus 101, a connection result screen displayed on the display unit 103 is similar to that of the above-described first embodiment, and thus a detailed description thereof is omitted. That is to say, the CPU 107 displays one of the screens depending on the connection result in step S305. Similarly, with reference to FIG. 8, a description is now given of display of a connection confirmation result on the user terminal 211. The CPU 212 displays the connection result of which it has been notified by the image forming apparatus 101 in step S605 on the display unit 217. A connection success screen 810 displays a product name and a device serial number of the image forming apparatus 101 that has connected to the user terminal 211, as well as a BLE connection success, and the CPU 212 closes the screen upon detecting pressing of an OK button 811. A connection failure screen 820 displays the product name and the device serial number of the image forming apparatus 101 that attempted to connect to the user terminal 211, as well as a message prompting reconfirmation of settings as the connection has failed, and the CPU 212 closes the screen upon detecting pressing of a close button 822.

In step S606, the CPU 212 acquires device information from the image forming apparatus 101 that has been connected via BLE. The device information includes the device serial number of the image forming apparatus 101. Here, it is desirable that the CPU 212 acquire, from the image forming apparatus 101, access information for accessing the license management server 201 and information related to selectable printing speeds, in addition to the device information. That is to say, here, information included in the code information of the above-described first embodiment is acquired. As processing of step S306 to step S314 is similar to the content that has been described using FIG. 3 in the above-described first embodiment, a description thereof is omitted.

As described above, the image forming apparatus according to the present embodiment presents a message prompting a Bluetooth connection with the image forming apparatus, enables BLE, and sends predetermined information including a device serial number. The user terminal presents a list of scanned BLE devices, and establishes a Bluetooth connection with a BLE device selected by a user. Also, the user terminal acquires device information and access information for accessing the server from the image forming apparatus via Bluetooth connection, and inputs a license key issued by the server to the image forming apparatus via Bluetooth connection. In this way, according to the present embodiment, at the time of registration of a speed license, connection is established by enabling the BLE functions of the image forming apparatus 101 and the user terminal 211 on a license input screen, and a speed license is acquired based on a selected printing speed. Furthermore, processing is executed to pass the speed license to the image forming apparatus 101 via BLE and activate the speed license; in this way, a desired printing speed can be set without performing cumbersome processing and a manual input.

### Third Embodiment

The following describes a third embodiment of the present disclosure. The above first and second embodiments have been described in relation to a mode in which connection is attempted via Wi-Fi communication, and a mode in which connection is attempted via BLE communication, with use of code information in order to connect the image forming apparatus 101 and the user terminal 211. The present embodiment will be described in relation to a method in which a similar effect is achieved by providing the image forming apparatus 101 with a camera and displaying a QR code on the user terminal 211. Today, image forming apparatuses that are offered for sale are configured in a variety of ways; for example, they are equipped only with the wireless LAN 114, equipped only with the BLE 115, or equipped with both options. Meanwhile, some image forming apparatuses are configured to have neither a wireless LAN nor BLE; a description is now given of a mode in which a desired printing speed can be set without performing cumbersome processing and a manual input even in the case of such a configuration. Regarding the system of the image forming apparatus 101 and the overall system of the image forming apparatus 101, the user terminal 211, and the license management server 201 shown in FIG. 1 and FIG. 2, the present embodiment is similar to the above-described first embodiment, and therefore a description thereof is omitted.

### Sequence

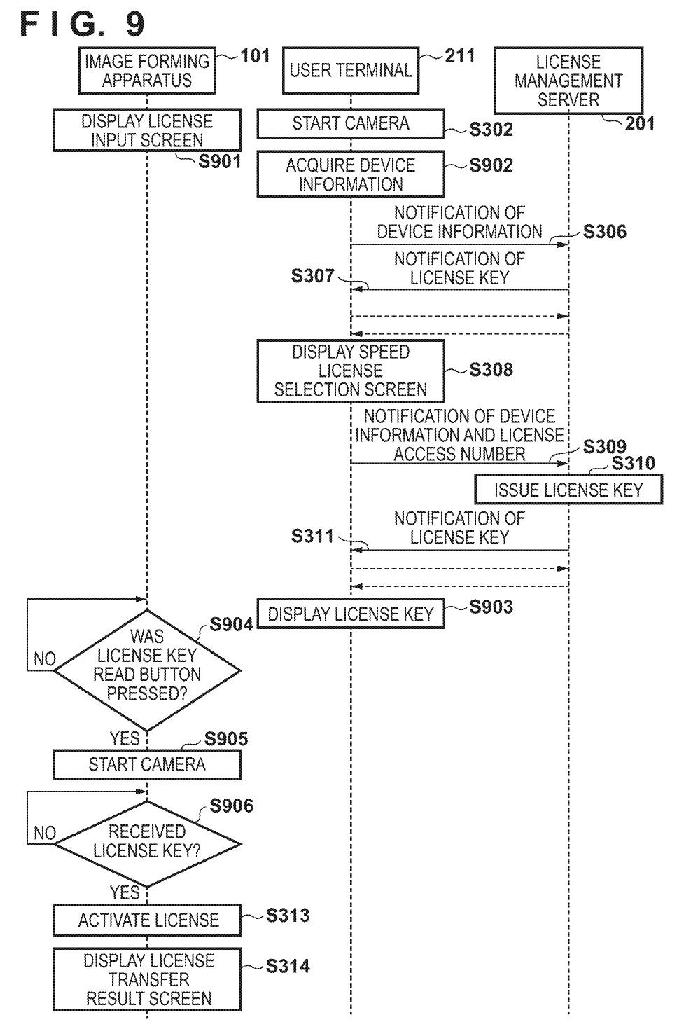

With reference to FIG. 9, a description is now given of a flow until a speed license is activated for the image forming apparatus 101 by the image forming apparatus 101, the user terminal 211, and the license management server 201 according to the present embodiment. The present processing is realized by the CPU 107 executing a control program in the image forming apparatus 101, the CPU 212 executing a control program in the user terminal 211, and the CPU 202 executing a program for execution of the server function in the license management server 201. Note that processing similar to that of the above-described first embodiment is given the same step numbers thereas, and a description thereof is omitted.

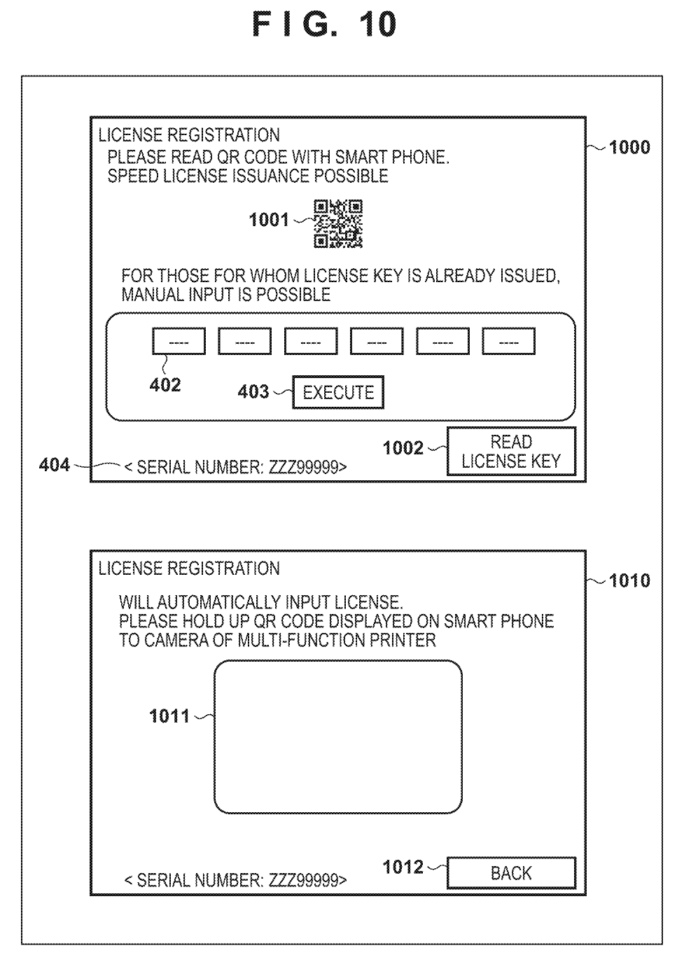

In step S901, the CPU 107 displays a license input screen on the display unit 103 in a case where a power source of the image forming apparatus 101 has been turned ON and a speed license has not been activated. Here, the CPU 107 is an example of presentation unit. As a determination method is similar to the above-described step S301, a detailed description thereof is omitted. Here, the license input screen displayed on the display unit 103 will be described with reference to FIG. 10. Display on the display unit 103 is controlled by the CPU 107. A license input screen 1000 is configured to include a QR code 1001, a speed license input section 402, an execution button 403, a device serial number 404 of the image forming apparatus 101, and a license key read button 1002. The CPU 107 generates and displays the QR code 1001, which stores the device serial number of the image forming apparatus 101 and a URL to the license management server 201. The QR code 1001 according to the present embodiment corresponds to related information for accepting an input of a license key that enables a printing speed. The present embodiment is described based on the premise that the user terminal 211 is not aware of the URL of the license management server 201. However, in a case where the user terminal 211 is configured to hold the URL of the license management server 201 in advance, like when a dedicated application for accessing the license management server 201 has been installed therein, the URL of the license management server 201 may not be included in the QR code 1001. Alternatively, the CPU 107 may store a URL of an installation server (not shown) of the dedicated application, in place of the URL of the license management server 201, in the QR code 1001. In this case, a similar effect can be achieved by accessing the license management server 201 from the dedicated application installed on the user terminal 211. The speed license input section 402 is an input space for accepting a manual input when a speed license has already been issued. As 402 to 404 are similar to those on the license input screen 400, a description thereof is omitted.

After the camera has been started in step S302, the CPU 212 reads the QR code 1001 displayed on the license input screen 1000, which was displayed in step S301, with use of the camera 218 in step S902. Furthermore, the CPU 212 extracts the device information of the image forming apparatus 101 and access information, such as the URL of the license management server, by decoding the QR code. The device information includes the aforementioned device serial number of the image forming apparatus 101.

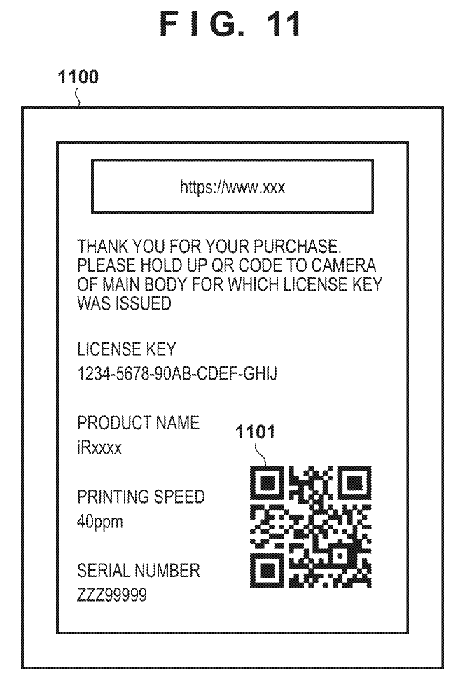

As processing of steps S306 to S311 is similar to that of the above-described first embodiment, a description thereof is omitted. In step S903, the CPU 212 generates a QR code that stores the speed license acquired in step S311, and displays the QR code on the display unit 217 of the user terminal 211. Here, a screen displayed on the display unit 217 will be described with reference to FIG. 11. A license QR display screen 1100 displays an indication that the speed license selected in step S308 has been purchased, as well as a QR code 1101 that stores the product name, purchased printing speed, device serial number, and speed license. The QR code 1101 is code information to be read by the camera 117 of the image forming apparatus 101.

In step S904, the CPU 107 stands by until it detects pressing of the license key read button 1002 on the license input screen 1000. Upon detection, processing proceeds to step S905. In step S905, the CPU 107 starts the camera 117, displays moving images that are currently captured by the camera 117 on the display unit 103, and waits for detection of the QR code that includes the speed license. Here, a license input screen displayed on the display unit 103 will be described with reference to FIG. 10. A license input screen 1010 is configured to include a camera image region 1011 and a return button 1012. Upon detecting pressing of the return button 1012, the CPU 107 displays the license input screen 1000 back again on the display unit 103.

In step S906, the CPU 107 determines whether a license key has been received. Specifically, upon detecting the QR code 1101 with use of the camera 117, the CPU 107 analyzes the QR code, and acquires a speed license. Upon receiving the license key, processing proceeds to step S313. As processing of steps S313 and S314 is similar to that of the above-described first embodiment, a description thereof is omitted.

As described above, the image forming apparatus according to the present embodiment generates and presents a code image, which includes device information of the image forming apparatus and access information for accessing the server, as related information. The user terminal extracts the device information of the image forming apparatus and the access information for accessing the server from the code image captured by the camera. The user terminal generates a code image that includes a license key issued by the server, displays the code image on the display unit of the user terminal, and causes the camera provided in the image forming apparatus to read the code image displayed on the display unit; consequently, the license key is input to the image forming apparatus. In this way, according to the present embodiment, at the time of registration of a speed license, the user terminal displays a speed license of a selected printing speed in the form of a QR code, and the speed license is activated by causing the image forming apparatus 101 to read the QR code. This enables a desired printing speed to be set without performing cumbersome processing and a manual input.

### Fourth Embodiment

The following describes a fourth embodiment of the present disclosure. The above first embodiment has been described in relation to an example in which, in order to connect the image forming apparatus 101 and the user terminal 211, a setup for Wi-Fi communication is simplified with use of a QR code in making the connection; meanwhile, the present embodiment will be described in relation to an example in which USB communication is used. Regarding the system of the image forming apparatus 101 and the overall system of the image forming apparatus 101, the user terminal 211, and the license management server 201 shown in FIG. 1 and FIG. 2, the present embodiment is similar to the first embodiment, and therefore a description thereof is omitted.

### Sequence

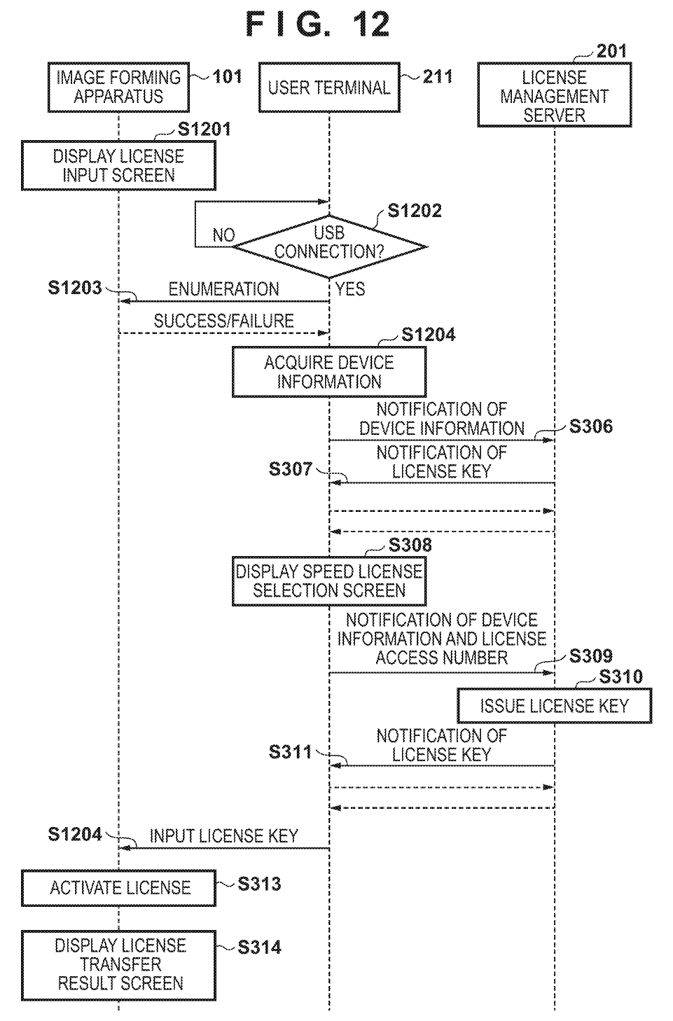

With reference to FIG. 12, a description is now given of a flow until a speed license is activated for the image forming apparatus 101 by the image forming apparatus 101, the user terminal 211, and the license management server 201 according to the present embodiment. The present processing is realized by the CPU 107 executing a control program in the image forming apparatus 101, the CPU 212 executing a control program in the user terminal 211, and the CPU 202 executing a program for execution of the server function in the license management server 201. Note that processing similar to that of the above-described first embodiment is given the same step numbers thereas, and a description thereof is omitted.

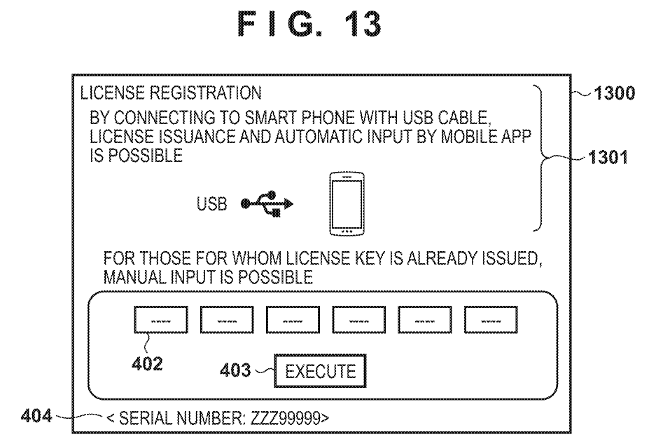

In step S1201, the CPU 107 displays a license input screen on the display unit 103 in a case where a power source of the image forming apparatus 101 has been turned ON and a speed license has not been activated. Here, the CPU 107 is an example of presentation unit. As a determination method is similar to the above-described step S301, a detailed description thereof is omitted. Here, a license input screen displayed on the display unit 103 will be described with reference to FIG. 13. Display on the display unit 103 is controlled by the CPU 107. A license input screen 1300 is configured to include a message 1301, a speed license input section 402, an execution button 403, and a device serial number 404 of the image forming apparatus 101. The message 1301 includes content prompting a USB connection between the image forming apparatus 101 and the user terminal 211. The message 1301 according to the present embodiment corresponds to related information for accepting an input of a license key that enables a printing speed. As 402 to 404 are similar to those on the license input screen 400, a description thereof is omitted.

In step S1202, the CPU 212 monitors a USB port (not shown) via the USB 220, and detects whether the user terminal 211 and a USB device have been connected via a USB cable. Upon detecting the connection, processing proceeds to step S1203. In step S1203, the CPU 212 performs enumeration via the USB 220, specifies the image forming apparatus 101, and establishes USB communication. The present embodiment will be described in relation to an example in which USB communication is performed with the user terminal 211 and the image forming apparatus 101 acting as a host and a target, respectively.

In step S1204, the CPU 212 acquires device information from the image forming apparatus 101 via the USB 220. The device information includes a device serial number of the image forming apparatus 101 and a URL of the license management server.

As steps S306 to S311 are similar to processing of FIG. 3 described in the above first embodiment, a description thereof is omitted. In step S1204, the CPU 212 notifies the image forming apparatus 101 of the speed license acquired in step S311. As a screen that is displayed on the display unit 217 at the time of this notification has been described above using FIG. 5B, a description thereof is omitted. The license transfer screen 570 displays, to a user, an indication that the speed license selected in step S308 has been purchased. Furthermore, the license transfer screen 570 displays, to the user, an indication that the speed license is to be transferred to the image forming apparatus 101 via a USB connection between the image forming apparatus 101 and the user terminal 211 that was made in steps S304 and S305. In addition, the license transfer screen 570 displays the product name, the purchased printing speed, and the device serial number. As processing of steps S313 and S314 is similar to that of the above-described first embodiment, a description thereof is omitted.

As described above, the image forming apparatus according to the present embodiment presents a message prompting a USB connection with the image forming apparatus as related information. The user terminal establishes a USB connection with the image forming apparatus via the USB cable, acquires device information and access information for accessing the server from the image forming apparatus via the USB connection, and inputs a license key issued by the server to the image forming apparatus via the USB connection. In this way, according to the present embodiment, at the time of registration of a speed license, a USB connection is established between the image forming apparatus 101 and the user terminal 211 on a license input screen, and a speed license is acquired in accordance with a selected printing speed. Furthermore, processing is executed to pass a license key to the image forming apparatus 101 via USB and activate the license key; in this way, a desired printing speed can be set without performing cumbersome processing and a manual input.

Note that the first to fourth embodiments of the present disclosure have been described above. Each apparatus in these embodiments may have a configuration that supports each embodiment, or may have a configuration that supports a plurality of embodiments. In a case where each apparatus has a configuration that supports a plurality of embodiments, it is desirable that a control function be switched in accordance with configurations of other apparatuses and the installation environment when a license key is activated.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-011661, filed January 27, 2025 which is hereby incorporated by reference herein in its entirety.

What is claimed is:

1. A system including an image forming apparatus, a user terminal, and a server,
the image forming apparatus comprising:
one or more first memory devices that store a set of instructions; and
one or more first processors that execute the set of instructions to
present related information for accepting an input of a license key that enables an image forming speed, and
enable the image forming speed in accordance with the input license key,
the user terminal comprising:
one or more second memory devices that store a set of instructions; and
one or more second processors that execute the set of instructions to
acquire device information of the image forming apparatus in accordance with the presented related information,
acquire selectable image forming speeds by notifying the server of the acquired device information of the image forming apparatus,
present the selectable image forming speeds and select an image forming speed in response to a user input, and
acquire a license key corresponding to the selected image forming speed from the server and input the license key to the image forming apparatus, and
the server comprising:
one or more third memory devices that store a set of instructions; and
one or more third processors that execute the set of instructions to
provide a notification of the selectable image forming speeds in accordance with the device information, and
issue the corresponding license key in accordance with the selected image forming speed.

2. The system according to claim 1, wherein
the one or more first processors execute instructions in the one or more first memory devices to generate and present, as the related information, a code image that includes access information for accessing the image forming apparatus and access information for accessing the server.

3. The system according to claim 2, wherein
the user terminal further comprises a camera, and
the one or more second processors execute instructions in the one or more second memory devices to extract the access information for accessing the image forming apparatus and the access information for accessing the server from the code image captured by the camera.

4. The system according to claim 3, wherein
the access information for accessing the image forming apparatus includes a device serial number, SSID information, and a password of the image forming apparatus, and
the one or more second processors execute instructions in the one or more second memory devices to
establish a Wi-Fi connection to the image forming apparatus with use of the access information for accessing the image forming apparatus,
acquire the device information from the image forming apparatus via the Wi-Fi connection, and
input a license key issued by the server to the image forming apparatus via the Wi-Fi connection.

5. The system according to claim 1, wherein
the one or more first processors execute instructions in the one or more first memory devices to present, as the related information, a message prompting a Bluetooth connection to the image forming apparatus.

6. The system according to claim 5, wherein
the one or more first processors execute instructions in the one or more first memory devices to, in a case where the related information is to be presented, enable BLE and send predetermined information including a device serial number, and
the one or more second processors execute instructions in the one or more second memory devices to present a list of scanned BLE devices, and establish a Bluetooth connection with a BLE device selected by a user.

7. The system according to claim 6, wherein
the one or more second processors execute instructions in the one or more second memory devices to
acquire the device information and access information for accessing the server from the image forming apparatus via the Bluetooth connection, and
input a license key issued by the server to the image forming apparatus via the Bluetooth connection.

8. The system according to claim 1, wherein
the one or more first processors execute instructions in the one or more first memory devices to generate and present, as the related information, a code image that includes the device information of the image forming apparatus and access information for accessing the server.

9. The system according to claim 8, wherein
the user terminal further comprises a camera, and
the one or more second processors execute instructions in the one or more second memory devices to extract the device information of the image forming apparatus and the access information for accessing the server from the code image captured by the camera.

10. The system according to claim 9, wherein
the one or more second processors execute instructions in the one or more second memory devices to generate a code image including the license key issued by the server, to display the generated code image on a display unit of the user terminal, and input the license key to the image forming apparatus by causing a camera provided in the image forming apparatus to read the code image displayed on the display unit.

11. The system according to claim 1, wherein
the one or more first processors execute instructions in the one or more first memory devices to present, as the related information, a message prompting a USB connection with the image forming apparatus.

12. The system according to claim 11, wherein
the one or more second processors execute instructions in the one or more second memory devices to establish a USB connection with the image forming apparatus via a USB cable.

13. The system according to claim 12, wherein
the one or more second processors execute instructions in the one or more second memory devices to
acquire the device information and access information for accessing the server from the image forming apparatus via the USB connection, and
input a license key issued by the server to the image forming apparatus via the USB connection.

14. An image forming apparatus, comprising:
one or more first memory devices that store a set of instructions; and
one or more first processors that execute the set of instructions to
present, to a user terminal, related information for accepting an input of a license key that enables an image forming speed,
accept the input of the license key that the user terminal has acquired from a server with use of the related information, and
enable the image forming speed in accordance with the input license key.

15. A user terminal, comprising:
one or more second memory devices that store a set of instructions; and
one or more second processors that execute the set of instructions to
acquire device information of an image forming apparatus in accordance with related information presented by the image forming apparatus, the related information being for accepting an input of a license key that enables an image forming speed,
acquire selectable image forming speeds by notifying a server of the acquired device information of the image forming apparatus,
present the selectable image forming speeds and select an image forming speed in response to a user input, and
acquire a license key corresponding to the selected image forming speed from the server and input the license key to the image forming apparatus.

16. A control method for a system that includes an image forming apparatus, a user terminal, and a server, the control method comprising:
in the image forming apparatus, presenting related information for accepting an input of a license key that enables an image forming speed;
in the image forming apparatus, enabling the image forming speed in accordance with the input license key;
in the user terminal, acquiring device information of the image forming apparatus in accordance with the presented related information;
in the user terminal, acquiring selectable image forming speeds by notifying the server of the acquired device information of the image forming apparatus;
in the user terminal, presenting the selectable image forming speeds and selecting an image forming speed in response to a user input;
in the user terminal, acquiring a license key corresponding to the selected image forming speed from the server and inputting the license key to the image forming apparatus;
in the server, providing a notification of the selectable image forming speeds in accordance with the device information; and
in the server, issuing the corresponding license key in accordance with the selected image forming speed.

17. A control method for an image forming apparatus, the control method comprising:
presenting, to a user terminal, related information for accepting an input of a license key that enables an image forming speed;
accepting the input of the license key that the user terminal has acquired from a server with use of the related information; and
enabling the image forming speed in accordance with the input license key.

18. A control method for a user terminal, the control method comprising:
acquiring device information of an image forming apparatus in accordance with related information presented by the image forming apparatus, the related information being for accepting an input of a license key that enables an image forming speed;
acquiring selectable image forming speeds by notifying a server of the acquired device information of the image forming apparatus;
presenting the selectable image forming speeds and selecting an image forming speed in response to a user input; and
acquiring a license key corresponding to the selected image forming speed from the server and inputting the license key to the image forming apparatus.

19. A non-transitory computer-readable storage medium storing a computer program for causing a computer to execute each process of a control method for an image forming apparatus, the control method comprising:
presenting, to a user terminal, related information for accepting an input of a license key that enables an image forming speed;
accepting the input of the license key that the user terminal has acquired from a server with use of the related information; and
enabling the image forming speed in accordance with the input license key.

20. A non-transitory computer-readable storage medium storing a computer program for causing a computer to execute each process of a control method for a user terminal, the control method comprising:
acquiring device information of an image forming apparatus in accordance with related information presented by the image forming apparatus, the related information being for accepting an input of a license key that enables an image forming speed;
acquiring selectable image forming speeds by notifying a server of the acquired device information of the image forming apparatus;
presenting the selectable image forming speeds and selecting an image forming speed in response to a user input; and
acquiring a license key corresponding to the selected image forming speed from the server and inputting the license key to the image forming apparatus.
